(19) United States
(12) Patent Application Publication
(10) Pub. No.: US 2012/0086674 A1
(43) Pub. Date: Apr. 12, 2012

(54) TOUCH SCREEN OPERATING PEN

(76) Inventors: Keyng Hun KIM, Gyeongsangnam-do (KR); Seung Kyo Park, Daejeon (KR); Chan Kuk Kim, Daejeon (KR)

(21) Appl. No.: 13/184,241

(22) Filed: Jul. 15, 2011

(30) Foreign Application Priority Data
Oct. 12, 2010 (KR) 20-2010-0010472

(51) Int. Cl. G06F 3/033

(52) U.S. Cl. 345/179

(57) ABSTRACT

A touch screen operating pen, by inserting a pen rubber supporter supporting the inside in the pen rubber section which touches and drags the touch panel/screen, which prevents the pen rubber section from being slipped to one side direction when the pen rubber section drags on the touch screen, and by securing a wider area where the pen rubber section contacts with the touch screen, which can touch and drag the touch panel/screen with a small power, and can effectively perform the touch and drag action while the pen rubber section contacts with the touch panel/screen. In addition, by interposing the plate spring having elastic force between the touch pen body and the pen rubber section which touches the touch panel/screen, it improves the click feeling and greatly raises the success rates of touch and click. Furthermore it can be used with the removable antenna or the constant pressure type touch pen.

### CROSS-REFERENCE TO RELATED APPLICATIONS

The present application claims priority under 35 U.S.C. 119 to Korean Patent Application No. 20-2010-0010472, filed on Oct. 12, 2010, the disclosure of which is expressly incorporated by reference herein in its entirety.

### TECHNICAL FIELD

The present invention relates to a touch screen operating pen. More specially by inserting a pen rubber supporter supporting the inside in the pen rubber section which touches and drags the touch panel/screen, it prevents the pen rubber section from being slipped to one side direction when the pen rubber section drags on the touch screen, and by securing a wider area where the pen rubber section contacts with the touch screen, it can touch and drag the touch panel/screen with a small power, and can effectively perform the touch and drag action while the pen rubber section contacts with the touch panel/screen. In addition, by interposing the plate spring having elastic force between the touch pen body and the pen rubber section which touches the touch panel/screen, it improves the click feeling and greatly raises the success rates of touch and click. Furthermore it can be used with the removable antenna or the constant pressure type touch pen, so the availability and convenience are more improved.

### BACKGROUND ART

Generally the touch screen (or panel) is included in the navigation apparatus installed at vehicle, the PDA terminal, the mobile, especially recently I phone, the tablet PC or the smart phone etc. The functions are exerted by pressing or touching the keyboard or icon displayed on the touch screen with hands or the touch pen.

As above, the capacitive type and the constant pressure type are selected for operating the keyboard or icon displayed on touch screen of various terminals. The capacitive type operates a keyboard or icons by sending the minute current flowing in human body to touch screen using human hands or a touch pen. The constant pressure type operates a keyboard or icons by pressing the touch screen using a pen rubber section of the touch pen equipped as a separate or using human hand directly.

In a conventional capacitive type, usually the finger has been used so that the current of the human body flow well. However it caused discomfort with many malfunctions because the touch area for the finger was too small to touch, so the point to touch and the other points not to touch were touched together. Therefore the touch pen has been developed for touching only desired points to flow current and for convenience with adjusting size of touch area adequately.

The capacitive touch pen as described above is composed of the pen body for hand's gripping and the pen rubber section, which touches the touch screen, installed at the end of the pen body, where the said pen body and the pen rubber section are made of a conductor to flow the human currents.

Therefore, the conventional capacitive touch pen composed of the conductor as described above has more decreased the malfunction that is occurred from the touching method using a hand which touches the keyboard or an icon, so the convenience of usage has been improved.

However the conventional capacitive touch pen, described in KR 10-2009-0091631 A or U.S. Pat. No. 5,999,170 and so forth, has disadvantage of a narrow contacting area in which the pen rubber section touches the touch screen, and has also lower success rate of click on the letter or an icon of keyboard the user wants owing to the lower adhesion.

Moreover, the typical capacitive touch pen, forming the space part in the pen rubber section of the touch pen, reduces user's click feeling or is pushed to touch with power for the user should press a little bit to feel the touch.

Meanwhile, the typical technique as above has no supporting means for the pen rubber section in the pen rubber section of the touch pen and thereby there is the problem that the pen rubber section is slipped to one side direction when the pen rubber section drags on the touch screen with keeping the click states after clicking the touch screen by the pen rubber section.

### TECHNICAL PROBLEM

The object of the present invention is to provide a touch screen operating pen, more specially by inserting a pen rubber supporter supporting the inside in the pen rubber section touching and dragging the touch panel/screen,, which prevents the pen rubber section from being slipped to one side direction when the pen rubber section drags on the touch screen, and by securing a wider area where the pen rubber section contacts with the touch screen, which can touch and drag the touch panel/screen with a small power, and can effectively perform the touch and drag action while the pen rubber section contacts with the touch panel/screen.

In addition, another object of the present invention is to provide a touch screen operating pen, by interposing the plate spring having elastic force between the touch pen body and the pen rubber section touching the touch panel/screen, which improves the click feeling and greatly raises the success rates of touch and chick.

Moreover, another object of the present invention is to provide a touch screen operating pen which can be used with the removable antenna or the constant pressure type touch pen.

### TECHNICAL SOLUTION

For solving the above problem, the present invention, which relates to a touch screen operating pen to click the letter or the icon displayed on touch screen by touching the touch screen of the portable terminal, PDA, a cellular phone or the smart phone, is characterized by comprising the touch pen body (100) of rod shape, the pen rubber section (200) installed at the end of the touch pen body (100) to touch or click the touch screen (10), and the pen rubber supporter (300) to support the said pen rubber section (200) interposed in the pen rubber section (200) and the support rubber (210) of the cross shape projected in the said pen rubber section (200).

Herein, the said pen rubber supporter (300) is engraved with the inserting groove (310) of cross shape to insert the support rubber (210) of the pen rubber section (200), and is characterized by being inserted in the said support rubber (210) of the pen rubber section (200).

In addition, the one end of the said pen rubber section (200) forming the protrusion (220) is inserted in the lower part of the touch pen body (100), and the other end forming the round part (230) of circle shape or forming the slope part (240) in one side direction is characterized to easily click or touch the said touch screen (10).

Furthermore, the said support rubber (210) projected in the pen rubber section (200) is formed with the pen rubber section (200) as one body. The one end of the said support rubber is projected at least beyond the middle of the entire length of the said pen rubber section (200) and the other end is extended the vicinity of the round part (230) or the slope part (240) of the said pen rubber section (200) and is characterized to be closed.

Meanwhile, it is characterized to include the plate spring (400) between the upper part of the said pen rubber section (200) and the lower part of the said touch pen body (100) so that the said pen rubber section (200) clicks or touches the touch screen (10) elastically.

### ADVANTAGEOUS EFFECTS

The present invention configured with the above characterization, by inserting the pen rubber supporter (300) in the pen rubber section (200) and by enclosing the outside with the housing (110) of the touch pen body (100) so that the said pen rubber supporter (300) and the said housing (110) support the inside and outside of the said pen rubber section (200), prevents the pen rubber section (200) from being slipped to one side direction when the pen rubber section (200) touches or drags on the touch screen (10), and also touches or drags the touch screen (10) with small power.

In addition, since the touch screen (10) is touched or dragged by using the entire area of the slope part (240) of the pen rubber section (200), it can be secured a wider area of the said pen rubber section (200) contacting on the said touch screen (10) with the small power and can be effectively performed the touch and drag action while the slope (240) of the said pen rubber section contacts with the said touch screen (10).

Moreover, by interposing the plate spring between the pen rubber section (200) and the touch pen body (100), the pressurized elastic force makes the pen rubber section (200) be more elastic when the said pen rubber section (200) is adhered on the touch screen (10) and thereby the efficiency of adhesion is improved to be better the click feeling and to raise the success rates of touch and click.

Furthermore the touch pen of the present invention can be used with the antenna or the constant pressure type touch pen by being included in the removable antenna equipped with the existing constant pressure touch pen.

### BRIEF DESCRIPTION OF THE DRAWINGS

FIG. 1 is the disassembled perspective drawing of the touch screen operating pen according to the exemplary embodiment of the present invention;

FIG. 2 is the side section drawing and the enlarged drawing of the touch screen operating pen according to the exemplary embodiment of the present invention;

FIG. 3 is the section drawing showing the touching state of the touch screen operating pen according to the exemplary embodiment of the present invention;

FIG. 4 is the section drawing showing the dragging state of the touch screen operating pen according to the exemplary embodiment of the present invention;

FIG. 5 is the side section drawing and the enlarged drawing of the touch screen operating pen according to another exemplary embodiment of the present invention;

FIG. 6 is the side section drawing and the enlarged drawing of the touch screen operating pen according to the other exemplary embodiment of the present invention;

### BEST MODE FOR INVENTION

Hereinafter, the embodiments of the present invention will be described with reference to accompanying drawings so as to be easily understood by a person ordinary skilled in the art. Note that the reference numbers for the configurations in attached figures are used the same numbers for the same configurations in other figures if it is possible. And in below description of the present invention, the detailed explanation is omitted in case the specific description related to the publicly known function or publicly known configuration makes unclear the gist of the present invention unnecessarily. Furthermore, the certain features is enlarged, abridged or simplified for the easier explanation. All of configurations in drawings are not illustrated to the proper rate.

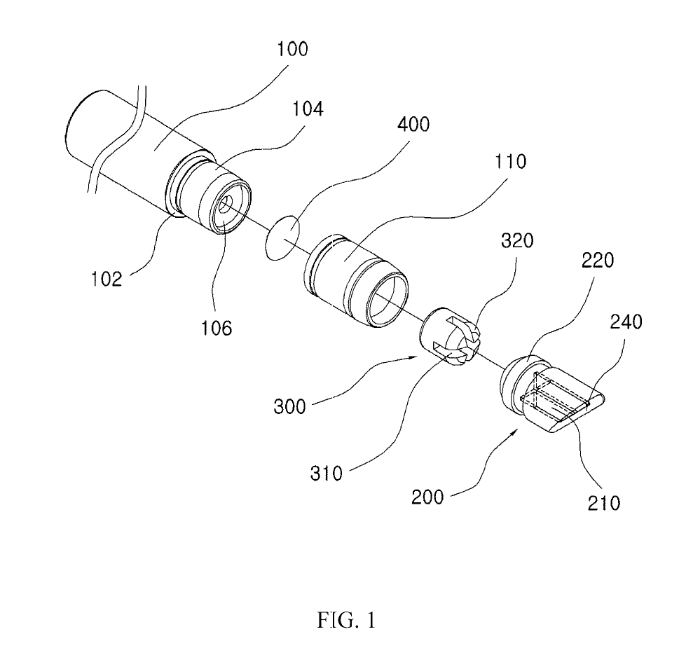

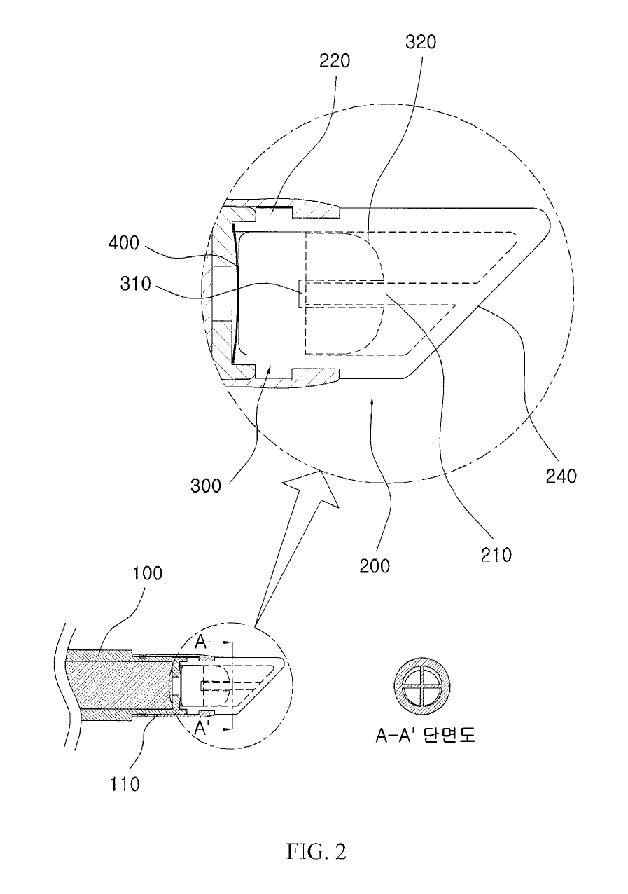

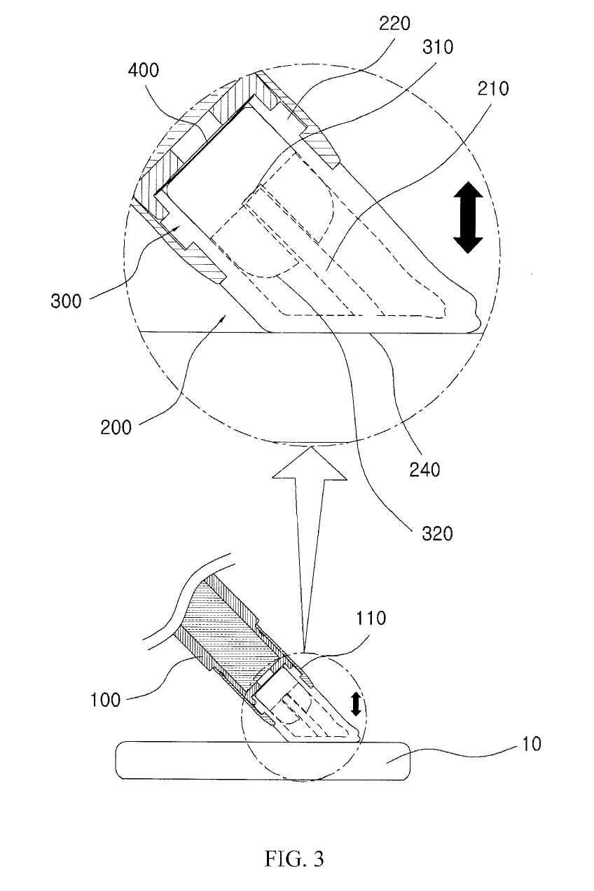

FIG. 1 is the disassembled perspective drawing of the touch screen operating pen according to the exemplary embodiment of the present invention. FIG. 2 is the side section drawing and the enlarged drawing of the touch screen operating pen according to the exemplary embodiment of the present invention. FIG. 3 is the section drawing showing the touching state of the touch screen operating pen according to the exemplary embodiment of the present invention.

As shown in FIG. 1 to FIG. 3, a touch screen operating pen according to the exemplary embodiment of the present invention comprise; the touch pen body (100) of rod shape, the pen rubber section (200) installed at the one end of the touch pen body (100), and the pen rubber supporter (300) interposed in the said pen rubber section (200).

Herein, the support rubber (210) of the cross shape is projected in the said pen rubber section (200).

In addition, the said pen rubber supporter (300) is engraved with the inserting groove (310) of cross shape and the said pen rubber supporter (300) is inserted in the said support rubber (210) of the pen rubber section (200).

Moreover, at the end of the said pen rubber section (200) is formed the protrusion (220), and at the other end is formed the round part (230) of circle shape or formed the slope part (240) in one direction.

Meanwhile, the said support rubber (210) projected in the pen rubber section (200) is formed with the pen rubber section as one body.

Besides, the plate spring (400) is included between the upper part of the said pen rubber section (200) and the lower part of the said touch pen body (100).

The said touch pen body (100) shapes like the rod so that users can grip it with the hand, and at the one end of the touch pen body is formed the step (102) and the other end is closed. The extension part (104), of which diameter is smaller than that of the said touch pen body (100), is projected from the one end to the opposite direction of the other end and the support step (106) is formed near the inner end of the said extension part (104).

And in the extension part (104) of the touch pen body (100) the hollowed housing (110) is inserted to combine closely with the step (102) of the said touch pen body (100).

Herein, the screw-up method or inserting method is suitable for the combination of the extension part (104) of the said touch pen body (100) and the said housing (110). However it is not limited thereto.

Besides, the said housing (110) can be formed with the touch pen body (100) as one body.

At the end of the said pen rubber section (200), the protrusion (200) is formed to insert in the lower part of the housing (100) and at the other end the slope part (240) is formed with the slope to one direction in order to easily click or touch the said touch screen (10). In the inside, the hollowed support rubber (210) of the cross shape is projected.

Herein, the one end of the said support rubber (210) is open to the direction of the said protrusion (220) and the other end is extended to the vicinity of the slope part (240) of the said pen rubber section (200) and is closed. The support rubber is formed with the pen rubber section (200) as one body.

The said pen rubber supporter (300) shapes like the cylinder with the round part (320) of a circle shape and is engraved with the inserting groove (310). Herein, the said inserting groove (310) is open to the direction of the said round part (320). The diameter of the said pen rubber section (300) is smaller than that of the said pen rubber (200). The inserting groove (310) of the said pen rubber supporter (300) is inserted in the support rubber (210) of the said pen rubber section (200) so that the pen rubber supporter (300) is fixed in the pen rubber section (200).

Herein, the said pen rubber supporter (300) prevents the said pen rubber section (200) from excessively inclining to one side direction. So it is preferable that the pen rubber supporter (300) is made of the metal or the hard synthetic resin to securely support to the pen rubber section (200).

Meanwhile, the shape of the support rubber (210) of the said pen rubber section (200) and the shape of the inserting groove (310) of the pen rubber supporter (300) are not limited to the cross shape. If the pen rubber supporter (300) supports the said pen rubber section (200) well, the shape can be changed to the various shapes like one line, cross, lattice or two lines.

The said plate spring (400), which has the elastic force, is interposed between the flat surface of the said pen rubber supporter (300) and the supporter step (106)formed at the end of the extension part (10) of the touch pen body (104) so that the said pen rubber section (200) clicks or touches the said touch screen (10).

Therefore, when the said pen rubber section (200) is dragged with touching the touch screen of the portable terminal, PDA, a cellular phone or the smart phone, the inside of the said pen rubber section (200) is supported by the pen rubber supporter (300) interposed in the said pen rubber section (200) and the outside is supported by the housing (100). Thereby, the pen rubber section (200) is not slipped to one side direction to perform drag action easily. If the said pen rubber section (200) is simply touched on the touch screen, the click feeling can be improved because of the elastic adhesion between the pen rubber supporter (300) and the plate spring (400) interposed at the end of the touch pen body (100).

Besides, since the touch action or the drag action is performed with the slope part (240) inclined to one direction in the pen rubber section (200), it can be secured a wider area to touch or drag. Thereby if the touch action or drag action is performed with the leading edge of the slope part (240), it can be touched or dragged in detail. That is, the effective touch action or drag action is performed with contacting the slope part (240) of the said pen rubber section on the touch screen.

Herein, the said pen rubber section (200) includes the conductive material to flow the minute current generated from the body of a user and is made of the rubber material or similar material to contact closely and softly on the said touch screen (10). In addition, the said plate spring (400) and the said pen rubber supporter (300) also includes the conductive material to flow the minute current generated from the human body through the pen rubber section (200).

Herein, the said touch pen body (10) can be manufactured with the said pen rubber supporter (300) as one body without the said plate spring (400).

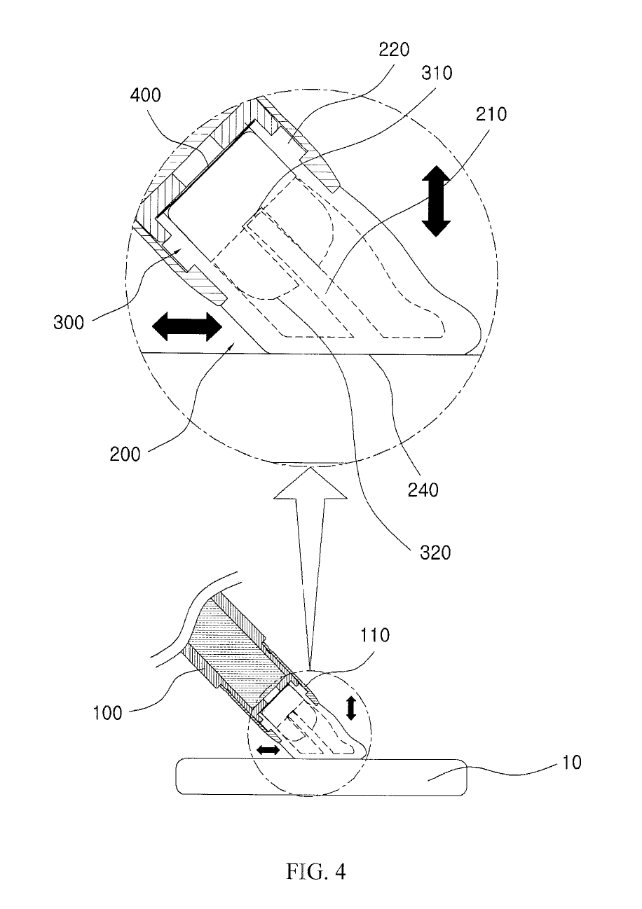

FIG. 4 is the section drawing showing the using state of the touch screen operating pen according to the exemplary embodiment of the present invention.

As shown in FIG. 3 and FIG. 4, the use of the touch screen operating pen according to the exemplary embodiment of the present invention is as follows.

Firstly, the touch action referring to FIG. 3 is explained. When the user grips the touch pen body (100) to click the letter or an icon displayed on the touch screen (10) and touches the said touch screen (10) tightly with the slope part (240) of the pen rubber section (200), the upper section of the said pen rubber section (200) is supported by the pen rubber supporter (300) with the touching force. At the same time, the upper section of the said pen rubber supporter (300) is pushed and raises the plate spring (400) and thereby the elastic reaction of the plate spring (400) actuates on the said pen rubber section (200). And at the same time, the elastic forces created by the contraction / relax of support rubber (210) of the said the pen rubber section (200) increasingly raise the success rate of the click when the slope part (2400 of the said pen rubber section (200) contacts on the said touch screen (10).

And since the entire slope part (240) of the said pen rubber section (200) contacts the said touch screen (10), it can be secured a wider area on which the pen rubber section contacts the said touch screen (10) without large power and thereby touch action can be effectively performed in state that the slope part (240) of the pen rubber section (200) contacts the said touch screen (10).

Next, drag action referring FIG. 4 is explained. When the user grips the touch pen body (100) and clicks the letter or an icon displayed on the touch screen (10) to drag, if the slope part (240) of the pen rubber section (200) touches the said touch screen (10) tightly and drags the pen rubber section (200) to the desired point with keeping the touching state, the pen rubber section (200) is bent to the opposite direction.

At that time, the inside of the said pen rubber section (200) prevents the support rubber (210) of the said pen rubber section (200) by means of the pen rubber supporter (300) inserted in the inside of the pen rubber section. At the same time, the outside of the pen rubber section (200) is supported with the housing (110) of the touch pen body (100) so that the slipping is greatly reduced when the said pen rubber section (200) is dragged the touch screen (10) with contacting, and thereby the touch action and the drag action can be performed with small power.

And since the entire slope part (240) of the said pen rubber section (200) contacts the said touch screen (10), it can be secured a wider area on which the pen rubber section contacts the said touch screen (10) without large power and thereby touch and drag action can be effectively performed in state that the slope part (240) of the pen rubber section (200) contacts the said touch screen (10).

The said pen rubber section (200) can be surely adhered on the said touch screen (10) even if the touch pen body (100) inclines to any direction. Therefore by the elastic force of the plate spring (400) and the elastic force of the support rubber (210) of the said pen rubber section (200), the click feeling is optimized and the success rate of the click is more improved when the said pen rubber section (200) touches and clicks the touch screen (10).

Therefore, even if the user clicks or drags any icon or letter of the said touch screen (10), the click action and the drag action is effectively performed. That is, the success rate of click is increasingly improved and also the slipping is minimized. In other words, the touch screen responds with the said pen rubber section (200).

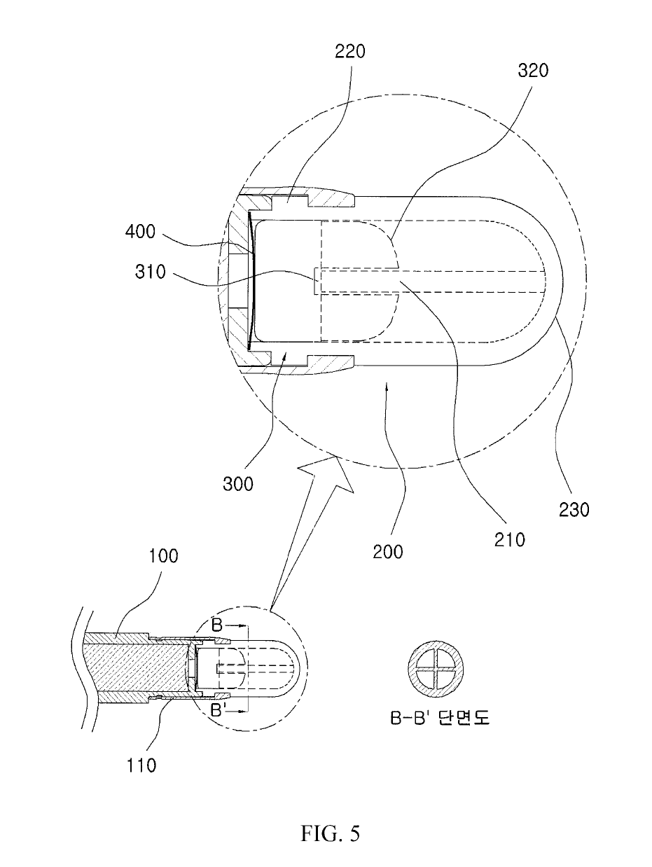

FIG. 5 is the side section drawing and the enlarged drawing of the touch screen operating pen according to another exemplary embodiment of the present invention.

As shown in FIG. 5, the other end of the pen rubber section (200) of the touch screen operating pen according to another exemplary embodiment can be formed of the round part (230) of circle shape. Thereby, the support rubber (210) of the said pen rubber section (200) can be extended to the vicinity of the round part (230) of the said pen rubber section (200). The detailed explanation is omitted because the other configuration is overlapped as above.

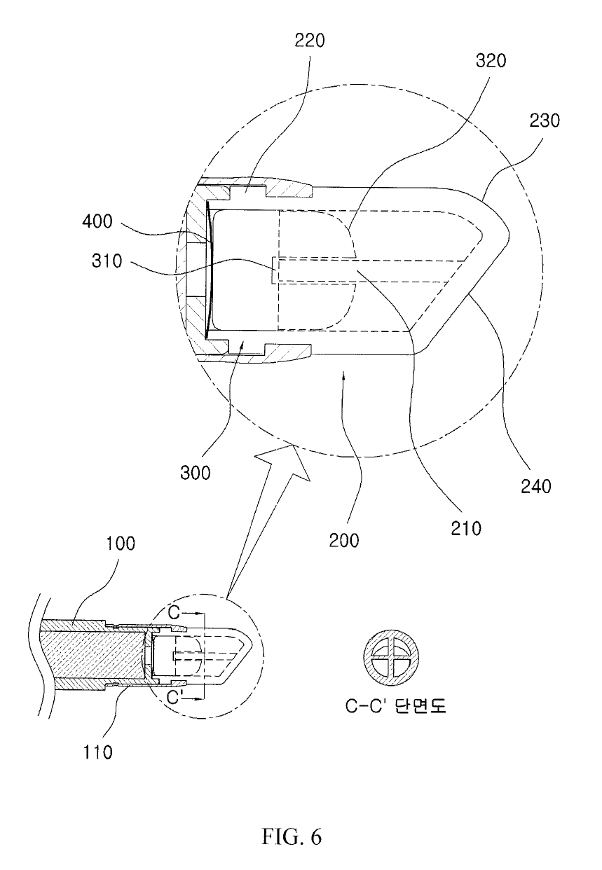

FIG. 6 is the side section drawing and the enlarged drawing of the touch screen operating pen according to the other exemplary embodiment of the present invention.

As shown in FIG. 6, the other end of the pen rubber section (200) of the touch screen operating pen according to another exemplary embodiment can be formed with the combination of the round part (230) of circle shape and the slope part (240) inclined to one direction. Thereby, the support rubber (210) of the said pen rubber section (200) can be extended to the vicinity of the round part (230) and the slope part (240) of the said pen rubber section (200). The detailed explanation is omitted because the other configuration is overlapped as above.

As described above, the touch screen operating pen according to the present invention can be applied to the existing removable antenna. Namely because the existing removable antenna is composed of the antenna body, the constant pressure type touch pen and the safe cap to protect the said constant pressure type touch pen, the one end of the antenna body can be connected the said constant pressure type touch pen, and the other end of the antenna body can be connected the said touch screen operating pen, and the said touch pen body can be used as a antenna. Like that, both of the said touch screen operating pen and the constant pressure type touch pen can be combined and used with the removable antenna. So it can be used very effectively.

That is, at the one end of the existing removable antenna is connected the touch screen operating pen and at the other end is connected the constant pressure type touch pen. In that way, the convenience of the user is more improved.

<The Description of Reference Numbers>

100: touch pen body, 102: step 104: the extension part 106: support step 110: housing 200: pen rubber section 210: support rubber 220: protrusion 230: round part 240: slope part 300: pen rubber supporter 310: inserting groove 320: round part 400: plate spring

What is claimed is:

1. A touch screen operating pen to click the letter or the icon displayed on touch screen by touching the touch screen of the portable terminal, PDA, a cellular phone or the smart phone, characterized by comprising; the touch pen body of rod shape; the pen rubber section installed at the end of the touch pen body to touch or click the touch screen wherein the support rubber of the cross shape is projected in the said pen rubber section.

2. A touch screen operating pen of claim 1, wherein a touch screen operating pen is characterized by more including the pen rubber supporter interposed in the said pen rubber section to support the pen rubber section.

3. A touch screen operating pen of claim 2, wherein the said pen rubber supporter is engraved with the inserting groove of cross shape and is inserted in the said support rubber of the pen rubber section.

4. A touch screen operating pen of claim 3, wherein at the one end of the said pen rubber section is formed the protrusion and interposed in the lower part of the said touch pen body, and at the other end is formed the round part of circle shape or formed the slope part in one direction to easily click or touch the said touch screen.

5. A touch screen operating pen of claim 1, wherein the said support rubber projected in the pen rubber section is formed with the pen rubber section as one body and the one end of the said support rubber is projected at least beyond the middle of the entire length of the said pen rubber section and the other end is extended the vicinity of the round part or the slope part of the said pen rubber section and is closed.

6. A touch screen operating pen of claim 2, wherein a plate spring is interposed between the upper part of the said pen rubber section and the lower part of the said touch pen body so that the said pen rubber section clicks or touches the touch screen elastically.
